(19) United States
(12) Patent Application Publication
(10) Pub. No.: US 2019/0089955 A1
(43) Pub. Date: Mar. 21, 2019

(54) IMAGE ENCODING METHOD, AND IMAGE ENCODER AND IMAGE DECODER USING SAME

(71) Applicant: INDUSTRY-ACADEMA COOPERATION GROUP OF SEJONG UNIVERSITY, Seoul (JP)

(72) Inventors: On Jin KWON, Gyeonggi-do (KR); Seung Cheol CHOI, Incheon (KR)

(21) Appl. No.: 15/999,734

(22) PCT Filed: Feb. 17, 2017
(86) PCT No.: PCT/KR2017/001800

§ 371 Date: Aug. 20, 2018

(30) Foreign Application Priority Data
Feb. 19, 2016 (KR) 10-2016-0019859
May 26, 2016 (KR) 10-2016-0064515
Feb. 3, 2017 (KR) 10-2017-0015839

(51) Int. Cl. H04N 19/12; H04N 19/186; H04N 19/625; H04N 19/124; H04N 19/91; H04N 19/30

(52) U.S. Cl. CPC H04N 19/12; H04N 19/186; H04N 19/30; H04N 19/124; H04N 19/91; H04N 19/625

(57) ABSTRACT

Disclosed is an image encoder comprising: a basic layer processor for converting a first dynamic range image into a second dynamic range image, and encoding the second dynamic range image so as to generate a basic layer code stream; an inverse quantizer for inversely quantizing the second dynamic range image quantized by the basic layer processor, and deriving DCT domain data; and an enhancement layer processor for deriving DCT domain data for the first dynamic range image, and deriving a first dynamic range image-related prediction coefficient from DCT domain data for the second dynamic range image and the DCT domain data for the first dynamic range image. According to the present invention, encoding and decoding, using the correlation of the first dynamic range image data and the second dynamic image data, of an HDR image having JPEG backward-compatibility can be provided such that encoding and decoding performance can be improved.

### TECHNICAL FIELD

The present invention relates to image encoding and decoding technology. More particularly, the present invention relates to a high-dynamic-range (HDR) image encoding and decoding method with JPEG backward compatibility, and an image encoder and image decoder using the same.

### BACKGROUND ART

Generally, images may be expressed by the limited number of bits corresponding to a limited range of values to represent luminance signals. The most common digital image format currently used employs 24 bits (so-called a 24-bit format) to store color and luminance information in each pixel within an image. For example, each value of red, green, and blue for a pixel may be stored in the range of 1 byte (8 bits). These images are called low-dynamic-range (hereinafter, referred to as “LDR”) images.

The brightness of light that a human can perceive has a particular range. The ratio of the minimum brightness to the maximum brightness that can be perceived is called a dynamic range. While the dynamic range of luminance that a human can perceive is from 10⁻³ through 10⁵ cd/m² (candela/m²), the dynamic range of a conventional normal digital camera/display using 8 bits per RGB color representation is limited only to about 10² cd/m².

Fortunately, in the camera industry, a changeover has begun from LDR images to high-dynamic-range (hereinafter, referred to as “HDR”) images that represent each RGB color with high-bit-depth such as 12 bits or 16 bits, or the like.

A high-bit-depth output device is required to display HDR images. However, most existing output devices still relate to the LDR, and this imbalance between input and output devices is expected to last for years in image industry. As a solution for visualizing an HDR image on an existing display, a method has been proposed using a tone-mapping operator (TMO) that converts an HDR image to an LDR image.

In the meantime, in image encoding, the legacy-JPEG (L-JPEG) standard (ISO/IEC 10918) still dominates the picture market. However, this standard does not support HDR images. Although advanced image encoding standards such as JPEG 2000 (ISO/IEC 15444) or JPEG XR (ISO/IEC 29199) supports HDR images, the adoption of HDR image encoding of these standards is not expected positively in the market.

The JPEG committee (SC29WG1) has recognized that the main reason of this phenomenon is caused by the lack of backward compatibility with L-JPEG, which is already a chain of tools in the market, and has initiated a new image encoding standardization work called JPEG XT (ISO/IEC 18477). Thee profiles called profiles A, B, and C have been proposed for JPEG XT, and there is a difference between the profiles in a method of generating and encoding a residual image.

As described above, a conventional JPEG XT system provides HDR W image encoding with backward compatibility, but has not yet achieved satisfactory results in terms of performance.

### DISCLOSURE

### Technical Problem

Accordingly, the present invention has been made keeping in mind the above problems, and an object of the present invention is to provide an image encoding method with JPEG backward compatibility.

Also, another object of the present invention is to provide an image decoding method with JPEG backward compatibility.

Also, still another object of the present invention is to provide an image encoder with JPEG backward compatibility.

Also, still another object of the present invention is to provide an image decoder with JPEG backward compatibility.

### Technical Solution

In order to accomplish the above object, according to an embodiment of the present invention, there is provided an image encoding method including: generating a base-layer code stream by converting a first dynamic-range image into a second dynamic-range image and encoding the second dynamic-range image; deriving discrete cosine transform (DCT) domain data of the second dynamic-range image; deriving DCT domain data for the first dynamic-range image; deriving a first dynamic-range-image related prediction coefficient from the DCT domain data for the second dynamic-range image and the DCT domain data for the first dynamic-range image; and deriving predicted DCT domain data for the first dynamic-range image using the DCT domain data for the second dynamic-range image and the first dynamic-range-image related prediction coefficient.

Here, the first dynamic-range image may be an HDR image, and the second dynamic-range image may be an LDR image.

The deriving of the first dynamic-range-image related prediction coefficient may include calculating the first dynamic-range-image related prediction coefficient using a correlation between the DCT domain data for the second dynamic-range image and the DCT domain data for the first dynamic-range image.

The image encoding method may further include: generating at least one residual coefficient using the predicted. DCT domain data for the first dynamic-range image derived from the DCT domain data for the second dynamic-range image and the first dynamic-range-image related prediction coefficient; and generating a residual-layer code stream containing the first dynamic-range-image related prediction coefficient and the residual coefficient.

The generating of the base-layer code stream may include: converting the first dynamic-range image into the second dynamic-range image by performing a tone-mapping operation thereon.

The generating of the base-layer code stream may also include: color-converting the second dynamic-range image; performing DCT on the color-converted image; quantizing the image on which DCT is performed; and entropy encoding the quantized image.

Here, an image quality coefficient used at the quantizing of the image on which DCT is performed may be equal to an image quality coefficient used in quantization of the residual coefficient.

Further, the deriving of the DCT domain data for the second dynamic-range image may include: performing inverse-quantization on the quantized image on which DCT is performed.

Here, an AC coefficient of the DCT domain data for the first dynamic-range image and an AC coefficient of the DCT domain data for the second dynamic-range image may have a correlation therebetween expressed in a function, such as a polynomial, an exponential function, a logarithmic function, a trigonometric function, or the like. Also, a DC coefficient of the DCT domain data for the first dynamic-range image and a DC coefficient of the DCT domain data for the second dynamic-range image may have a correlation expressed in a prediction curve including multiple sections, and the sections of the prediction curve may be defined by a same or different functions, such as polynomials, exponential functions, logarithmic functions, trigonometric functions, or the like.

In order to accomplish another object, according to an embodiment of the present invention, there is provided an image decoding method including: receiving a residual-layer code stream containing a first dynamic-range-image related prediction coefficient; generating a second dynamic-range image by receiving a base-layer code stream and by decoding the received base-layer code stream; deriving DCT domain data for the second dynamic-range image; deriving residual DCT domain data; calculating predicted DCT domain data for the first dynamic-range image from the first dynamic-range-image related prediction coefficient and the DCT domain data for the second dynamic-range image; reconstructing DCT domain data for the first dynamic-range image by adding the residual DCT domain data and the predicted DCT domain data for the first dynamic-range image; and generating the first dynamic-range image by decoding the DCT domain data for the first dynamic-range image.

Here, the first dynamic-range image may be an HDR image, and the second dynamic-range image may be an LDR image.

The calculating of the predicted DCT domain data for the first dynamic-range image may include: deriving the first dynamic-range-image related prediction coefficient from a residual code stream; and applying a function based on the first dynamic-range-image related prediction coefficient to the DCT domain data for the second dynamic-range image.

In order to accomplish another object, according to another embodiment of the present invention, there is provided an image decoding method including: receiving a residual-layer code stream containing a first dynamic-range-image related prediction coefficient; deriving spatial domain data of a second dynamic-range image by receiving a base-layer code stream and performing inverse-discrete cosine transform (inverse-DCT) on the received base-layer code stream; calculating prediction-spatial-domain data of the first dynamic-range image from the first dynamic-range-image related prediction coefficient and the spatial domain data of the second dynamic-range image; performing inverse-DCT on a residual signal contained in the residual-layer code stream; and reconstructing the first dynamic-range image from spatial prediction data of the first dynamic-range image and the residual signal on which inverse-DCT is performed.

Here, the first dynamic-range image may be an HDR image, and the second dynamic-range image may be an LDR image.

The calculating of the prediction-spatial-domain data of the first dynamic-range image may include: deriving the first dynamic-range-image related prediction coefficient from a residual code stream; and applying a function based on the first dynamic-range-image related prediction coefficient to the spatial domain data of the second dynamic-range image.

In order to accomplish another object, according to another embodiment of the present invention, there is provided an image encoder including: a base-layer processor generating a base-layer code stream by converting a first dynamic-range image into a second dynamic-range image and encoding the second dynamic-range image; an inverse-quantizer deriving DCT domain data by performing inverse-quantization on the second dynamic-range image quantized by the base-layer processor; and an enhancement-layer processor deriving DCT domain data for the first dynamic-range image, and deriving a first dynamic-range-image related prediction coefficient from the DCT domain data for the second dynamic-range image and the DCT domain data for the first dynamic-range image.

Here, the first dynamic-range image may be an HDR image, and the second dynamic-range image may be an LDR image.

The enhancement-layer processor may include a predictor calculating the first dynamic-range-image related prediction coefficient and predicted DCT domain data for the first dynamic-range image using a correlation between the DCT domain data for the second dynamic-range image and the DCT domain data for the first dynamic-range image.

Also, the enhancement-layer processor may be configured to: generate at least one residual coefficient using the predicted DCT domain data for the first dynamic-range image derived from the DCT domain data for the second dynamic-range image and the first dynamic-range-image related prediction coefficient; and generate the residual-layer code stream containing the first dynamic-range-image related prediction coefficient and the residual coefficient.

Here, an image quality coefficient used in quantization of the second dynamic-range image performed by the base-layer processor may be equal to an image quality coefficient used in quantization of the residual coefficient performed by the enhancement-layer processor.

In the meantime, the base-layer processor may include a tone-mapping operator converting the first dynamic-range image into the second dynamic-range image by performing a tone-mapping operation thereon, and may include: a color converter color-converting the second dynamic-range image; a discrete cosine transformer performing DCT on the color-converted image; a quantizer quantizing the image on which DCT is performed; and an entropy encoder entropy encoding the quantized image.

In order to accomplish another object, according to another embodiment of the present invention, there is provided an image decoder including: a base-layer decoder receiving a base-layer code stream, decoding the base-layer code stream, deriving DCT domain data of a second dynamic-range image, and generating the second dynamic-range image; and an enhancement-layer decoder receiving a residual-layer code stream containing a first dynamic-range-image related prediction coefficient, calculating DCT domain data of a first dynamic-range image from the first dynamic-range-image related prediction coefficient and the DCT domain data for the second dynamic-range image, and performing inverse-DCT on the DCT domain data for the first dynamic-range image so as to reconstruct the first dynamic-range image.

In order to accomplish another object, according to another embodiment of the present invention, there is provided an image decoder including: a base-layer decoder receiving a base-layer code stream, and performing entropy decoding, inverse-quantization, and inverse-DCT on the base-layer code stream to derive a second dynamic-range image; and an enhancement-layer decoder receiving a residual-layer code stream containing a first dynamic-range-image related prediction coefficient and a residual signal, calculating spatial prediction data of the first dynamic-range-image from the first dynamic-range-image related prediction coefficient and spatial domain data of the second dynamic-range image, and reconstructing the first dynamic-range image from the spatial prediction data of the first dynamic-range image and a residual signal on which inverse-DCT is performed.

### Advantageous Effects

The HDR image encoding method and decoding method according to the embodiments of the present invention may provide HDR image encoding and decoding with JPEG backward compatibility using a correlation between a tone-mapped LDR image and an HDR image in a DCT domain, such that encoding and decoding performance may be enhanced.

### DESCRIPTION OF DRAWINGS

FIG. 1 is a block diagram illustrating a configuration of a JPEG XT encoding system.

FIG. 2 is a block diagram illustrating a configuration of an HDR image encoder according to an embodiment of the present invention.

FIG. 3 is a block diagram illustrating a configuration of an HDR image decoder according to an embodiment of the present invention.

FIG. 4 is a diagram illustrating multiple image samples for describing the result of an experiment of an HDR image encoding method and decoding method according to an embodiment of the present invention.

FIG. 5 is a diagram illustrating an example of distribution of AC coefficients for various TMOs according to an embodiment of the present invention.

FIG. 6 is a diagram illustrating an example of distribution of DC coefficients for various TMOs according to an embodiment of the present invention.

FIG. 7 is a graph illustrating a concept of deriving a predicted HDR DC value according to another embodiment of the present invention.

FIG. 8 is a block diagram illustrating a configuration of an HDR image decoder according to another embodiment of the present invention.

FIG. 9 is a flowchart illustrating operation of an encoding method according to an embodiment of the present invention.

FIG. 10 is a flowchart illustrating operation of a decoding method according to an embodiment of the present invention.

FIG. 11 is a flowchart illustrating operation of a decoding method according to another embodiment of the present invention.

### BEST MODE

The present invention may be modified in various ways and implemented by various embodiments, so that specific embodiments are shown in the drawings and will be described in detail. However, it is to be understood that the present invention is not limited to the specific exemplary embodiments, but includes all modifications, equivalents, and substitutions included in the spirit and the scope of the present invention. In describing the accompanying drawings, like reference numerals designate like elements.

Although the terms first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present invention belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, exemplary embodiments of the present invention will be described in detail with reference to the accompanying drawings.

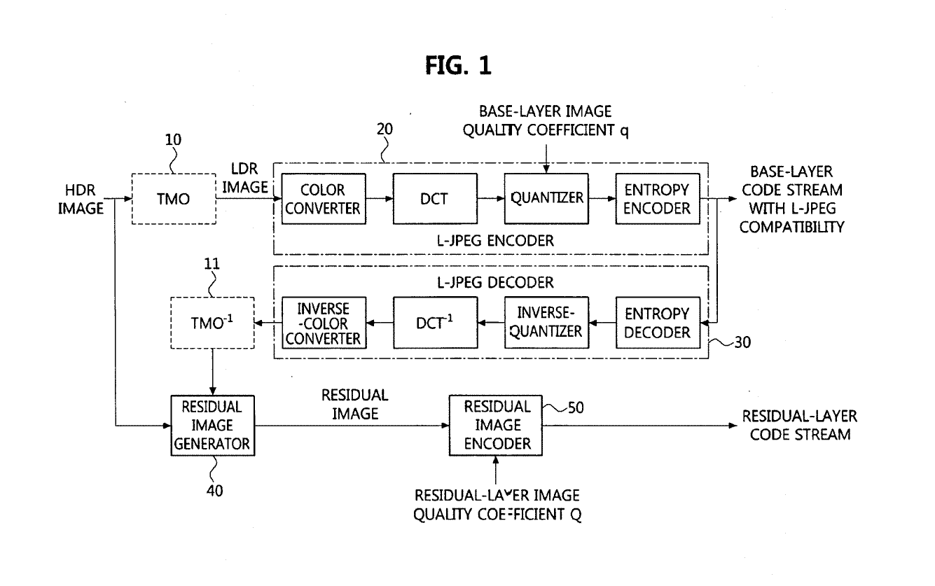

FIG. 1 is a block diagram illustrating a configuration of a JPEG XT encoding system.

The JPEG XT encoding system shown in FIG. 1 may apply to profiles A, B, and C.

As shown in FIG. 1, the JPEG XT encoding system includes: a tone-mapping operator 10, an inverse-TMO 11, a residual image generator 40, and a residual image encoder 50 besides a legacy-JPEG encoder 20 and a legacy-JPEG decoder 30.

The JPEG XT encoding system including these detailed constituents outputs data of two layers which are a base-layer code stream and an enhancement-layer code stream, namely, a residual-layer code stream.

An HDR image input to the JPEG XT encoding system is converted into an LDR image by being tone-mapped by the tone-mapping operator 10, and the LDR image is compressed by the legacy-JPEG encoder, which includes a color converter, a discrete cosine transformer, a quantizer, and an entropy encoder, whereby a base-layer code stream providing legacy-JPEG backward compatibility is constructed.

The HDR image is processed by the tone-mapping operator 10, the legacy-JPEG encoder 20, the legacy-JPEG decoder 30, and the inverse-TMO 11 such that the resulting signal is output, the resulting signal and an HDR signal are input to the residual image generator 40 to generate a residual image, and the residual image is input to the residual image encoder 50, whereby an enhancement-layer (namely, a residual layer) code stream is generated.

Here, quantizers of the legacy-JPEG encoder 20 and the residual image encoder 50 use two image quality coefficients q and Q, respectively. Also, choice for the TMO is given to a user, and thus any TMO may be used with JPEG XT. Information on the inverse-TMO 11 may be contained in the residual-layer code stream which is used by the residual layer decoder to reconstruct the HDR version of an LDR code stream.

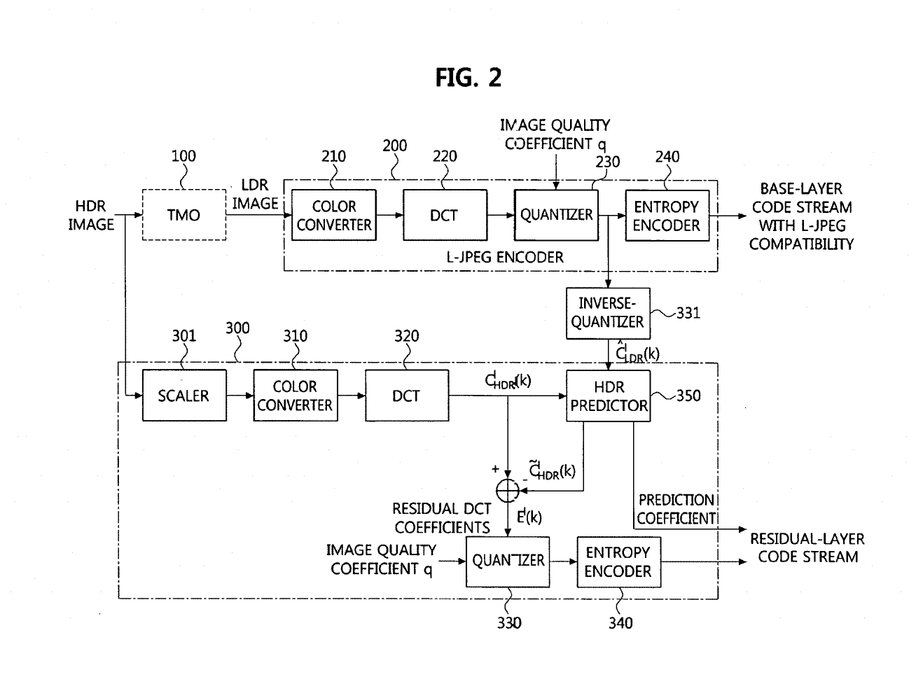

FIG. 2 is a block diagram illustrating a configuration of an HDR image encoder according to an embodiment of the present invention.

According to the embodiment of the present invention, an image encoder includes a tone-mapping operator 100 and a legacy-JPEG encoder 200. In the specification, the tone-mapping operator 100 and the legacy-JPEG encoder 200 may be referred to as a base-layer processor.

According to the embodiment of the present invention, unlike the JPEG XT encoder shown in FIG. 1, the image encoder does not include the legacy-JPEG decoder, but includes an enhancement-layer processor 300, which includes a scaler 301, a color converter 310, a discrete cosine transformer 320, a quantizer 330, an entropy encoder 340, and an HDR predictor 350, and an inverse-quantizer 331.

According to the embodiment of the present invention, the image encoder may include: a base-layer processor converting a first dynamic-range image into a second dynamic-range image and encoding the second dynamic-range image so as to generate a base-layer code stream; an inverse-quantizer performing inverse-quantization on the second dynamic-range image quantized by the base-layer processor to derive DCT domain data; and an enhancement-layer processor deriving DCT domain data for the first dynamic-range image and deriving a first dynamic-range-image related prediction coefficient from the DCT domain data for the second dynamic-range image and the DCT domain data for the first dynamic-range image.

Here, the first dynamic-range image is expressed using a substantial amount of data than the second dynamic-range image. The first dynamic-range image may be the HDR image, and the second dynamic range image may be the LDR.

Here, the enhancement-layer processor 300 may include the predictor 350 calculating the first dynamic-range-image related prediction coefficient using a correlation between the DCT domain data for the second dynamic-range image and the DCT domain data for the first dynamic-range image.

Also, the enhancement-layer processor generates at least one residual coefficient using the DCT domain data for the first dynamic-range image and the first dynamic-range-image related prediction coefficient, and generates a residual-layer code stream containing the first dynamic-range-image related prediction coefficient and at least one residual coefficient.

HDR image encoding with JPEG backward compatibility according to the present invention may be implemented through the example of the image encoder as shown in FIG. 2.

In FIG. 2, base-layer encoding applies in the same manner as the conventional profiles. That is, the HDR image input to the image encoder according to the present invention is converted into the LDR image by being tone-mapped by the tone-mapping operator (TMO) 100, and the LDR image is compressed by the legacy-JPEG encoder 200, which includes a color converter 210, a discrete cosine transformer 220, a quantizer 230, and an entropy encoder 240, whereby a base-layer code stream providing legacy-JPEG backward compatibility is constructed.

Here, the tone-mapping operator 100 performs so-called compression of a dynamic range, in which the HDR image is converted into an 8-bit LDR image by being tone-mapped without losing the features, details, and the like of edge information of the original image.

The color converter 210 performs YCbCr conversion on the LDR image expressed in red-green-blue (RGB). The discrete cosine transformer 220 performs 8×8 block-based DCT on the image data expressed in YCbCr. Here, DCT is one of widely used techniques for image frequency conversion, wherein a cosine basis is used to transform image data in a spatial domain into image data in a frequency domain. When DCT is performed, DC and AC constituents, namely, a DC coefficient and an AC coefficient are obtained as result values.

The quantizer 230 receives the transform coefficient transformed into the frequency domain by the discrete cosine transformer 220 as an input value and maps the transform coefficient to a discrete value. Data loss occurs in the quantization process, and continuous or a large amount of input data is mapped to a small number of discrete symbols after quantization. Further, the entropy encoder 240 receives the output from the quantizer 230 and performs entropy encoding thereon. Here, entropy encoding is lossless compression and is a process of allocating the length of the symbol differently according to the symbol occurrence probability so as to minimize the amount of data required in expression.

In the meantime, residual-layer encoding according to the embodiment of the present invention shown in FIG. 2 is clearly distinguished from residual-layer encoding shown in FIG. 1.

First, an input HDR image is input to the scaler 301. The scaler 301 scales the pixel value range of the input HDR image to the LDR image range. Here, scaling is a uniform and reversible floating-point scaling operation. When the scaling operation is completed, color expression of the LDR image is converted into YCbCr expression by the color converter 310, and 8×8 block-based DCT is performed by the discrete cosine transformer 320.

One of the main features of HDR image encoding proposed in the present invention is to perform HDR prediction based on a DCT coefficient of the tone-mapped LDR image encoded in the base layer and each DCT coefficient of the input HDR image, and to generate a prediction coefficient and a residual-layer code stream. Related to this, the HDR predictor 350 shown in FIG. 2 performs this.

The HDR predictor 350 receives output from the inverse-quantizer 331 that performs inverse-quantization on the data output from the quantizer 230 in the encoder 200, namely, receives the DCT coefficient of the tone-mapped LDR image as input. Also, the HDR predictor 350 receives the DCT coefficient of the input HDR image as another input, and derives a predicted HDR DCT coefficient and a prediction coefficient.

The difference between the DCT coefficient of the input HDR image and the predicted HDR DCT coefficient forms a residual DCT coefficient. The residual DCT coefficient is quantized by the quantizer 330 and entropy encoded by the entropy encoder 340. Here, the quantizer 330 performs the same function as the quantizer 230 in the encoder, and the entropy encoder 340 performs the same function as the entropy encoder 240 in the encoder.

Here, it is noted that in the conventional profiles shown in FIG. 1, two image quality coefficients are used for base-layer encoding and residual-layer encoding, respectively. On the other hand, in the HDR image encoding system according to the embodiment of the present invention shown in FIG. 2, the image quality coefficient q used in the base layer may be used equally in the residual layer.

The residual-layer code stream, which is generated finally, is composed of prediction coefficients estimated by the HDR predictor 350 and the entropy encoded residual DCT coefficient.

In the meantime, the discrete cosine transformer 220 in the base-layer encoding process and the discrete cosine transformer 320 in the residual-layer encoding process perform block-based DCT on each Y, Cb, and Cr color elements of the input image, and the resulting DCT coefficients are rearranged into one-dimensional vectors in a zigzag sequence.

In FIG. 2, the k-th DCT coefficient in the 1-th block of the input HDR image output from the discrete cosine transformer 320 is designated by C^{l}_{HDR}(k), and the inverse-quantized DCT coefficient of the tone-mapped LDR image output from the inverse-quantizer 331 is designated by Ĉ^{l}_{LDR}(k). Further, C^{l}_{HDR}(0) and Ĉ^{l}_{LDR}(0) are defined as DC coefficients, and C^{l}_{HDR}(k) and Ĉ^{l}_{LDR}(k), wherein k is not 0, are defined as AC coefficients.

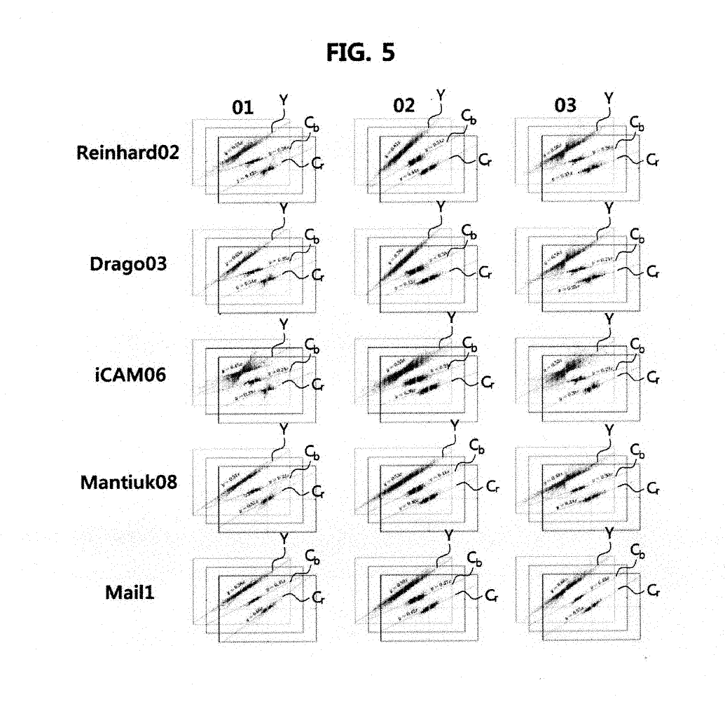

The HDR predictor 350 predicts C^{l}_{HDR}(k) based on Ĉ^{l}_{LDR}(k) with respect to each Y, Cb, and Cr color elements. For prediction according to the present invention, a correlation between Ĉ^{l}_{LDR}(k) and C^{l}_{HDR}(k) is used for two types DC and AC of coefficients. Estimation of the prediction coefficient performed by the HDR predictor 350 will be described in detail with reference to FIGS. 5 to 7.

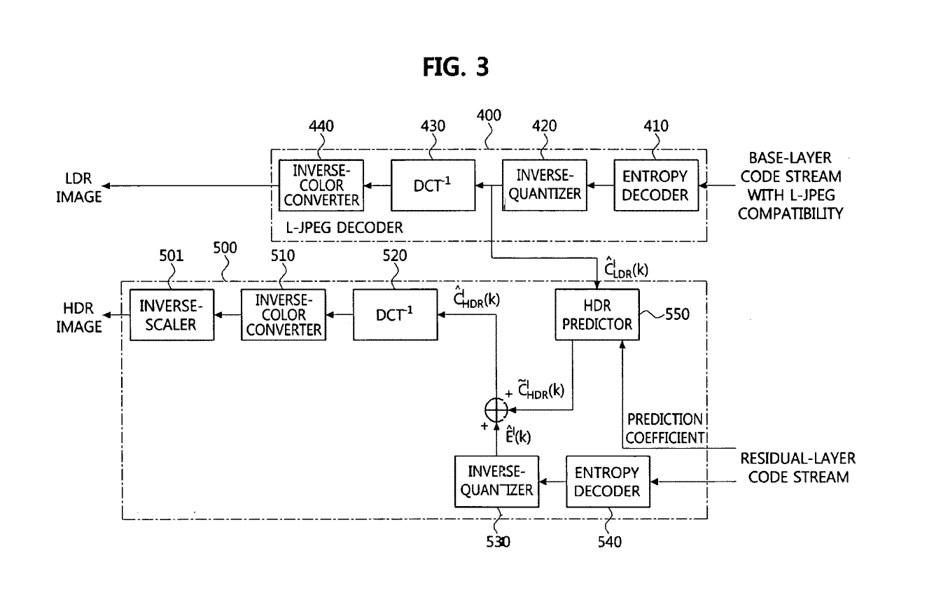

FIG. 3 is a block diagram illustrating a configuration of an HDR image decoder according to an embodiment of the present invention.

HDR image decoding which is the reverse process of HDR image encoding according to the present invention will be described with reference to FIG. 3.

As shown in FIG. 3, an HDR image decoder according to the present invention may include: a base-layer decoder 400 processing a legacy-JPEG compatible base-layer code stream; and an enhancement-layer decoder 500.

The base-layer decoder 400 is configured to: receive a base-layer code stream; decode the base-layer code stream; derive a DCT domain data of a second dynamic-range image; and generate the second dynamic-range image. The enhancement-layer decoder 500 is configured to: receive a residual-layer code stream containing a first dynamic-range-image related prediction coefficient; derive the first dynamic-range-image related prediction coefficient and residual DCT domain data; calculate predicted DCT domain data for the first dynamic-range image from the first dynamic-range-image related prediction coefficient and the DCT domain data for the second dynamic-range image; and reconstruct DCT domain data for the first dynamic-range image by adding the predicted DCT domain data for the first dynamic-range image and the residual DCT domain data.

The enhancement-layer decoder 500 may include: an HDR predictor 550 for processing a residual-layer code stream; an entropy decoder 540; an inverse-quantizer 530; an inverse-color converter 510; and an inverse-scaler 501.

Base layer decoding shown in FIG. 3 is performed by the conventional legacy-JPEG decoder 400, and the legacy-JPEG decoder 400 may include an entropy decoder 410, an inverse-quantizer 420, an inverse-discrete cosine transformer 430, and an inverse-color converter 440.

In FIG. 3, the base-layer code stream input to the image decoder is converted into a stream in the quantized form by the entropy decoder 410, and is converted into Ĉ^{l}_{LDR}(k) expressed in the DCT domain by the inverse-quantizer 420. Data in the DCT domain finally is converted into the LDR image expressed in RGB by the inverse-discrete cosine transformer 430 and the inverse-color converter 440.

In the meantime, the prediction coefficients contained in the residual-layer code stream are input to the HDR predictor 550, and the residual-layer code stream is converted into the DCT coefficient Ê^{l}(k) of the residual signal through the entropy decoder 540 and the inverse-quantizer 530.

Also, the HDR predictor 550 receives Ĉ^{l}_{LDR}(k) and prediction coefficients contained in the residual-layer code stream as input, and derives a predicted HDR DCT coefficient \tilde{C}^{l}_{HDR}(k) through HDR prediction.

The HDR predictor 550 in the decoding according to the embodiment of the present invention uses the prediction coefficients contained in the residual-layer code stream to derive the HDR DCT coefficient that is the same as the predicted HDR DCT coefficient derived by the HDR predictor 350 of the encoder shown in FIG. 2.

The DCT coefficient Ê^{l}(k) of the residual signal is added to the predicted HDR DCT coefficient \tilde{C}^{l}_{HDR}(k) such that a recovered HDR DCT coefficient Ĉ^{l}_{HDR}(k) is obtained, and the recovered HDR DCT coefficient is finally recovered to the HDR image through an inverse-discrete cosine transformer 520, the inverse-color converter 510, and the inverse-scaler 501.

As shown in the embodiments in FIGS. 2 and 3, the HDR image encoding method and decoding method according to the present invention differs from the conventional profiles described in FIG. 1 in the following two points.

First, the conventional profiles generate their residual images in the spatial domain. Thus, conventionally, a full L-JPEG decoding process is required in JPEG XT encoding as shown in FIG. 1.

Also, the conventional profiles A and B generate their residual images in the form of images in which the HDR original image at each pixel is divided into tone-mapped LDR images for each pixel, and the profile C takes a differential image between the HDR original image and the tone-mapped LDR image as a residual image. However, in the present invention, residual data is generated in the DCT domain. Also, the L-JPEG decoding process is not required in JPEG XT encoding according to the present invention, which means an effect of reducing the encoding time.

Second, the conventional profiles use two image quality coefficients (quality factors). One is used for the base layer and the other one is used for the residual layer, which are designated by q and Q, respectively, as shown in FIG. 1. Expert users will find the most optimal combination of two image quality coefficients for effective image encoding, but this is difficult for ordinary users. The present invention enables a single image quality coefficient, which optimizes coding rate-distortion, to be used to encode base and residual layers together, thereby enhancing user convenience.

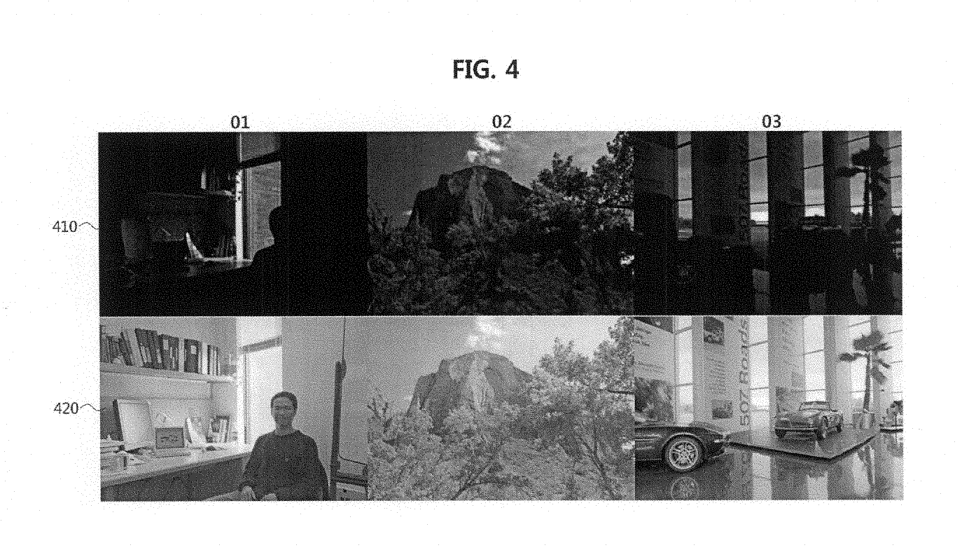

FIG. 4 is a diagram illustrating multiple images for describing the result of an experiment of an HDR image encoding method and decoding method according to an embodiment of the present invention.

In the DC coefficient and the AC coefficient according to the present invention, three different HDR sample images as shown in the upper part (a) of FIG. 4 were used in order to check the correlation between Ĉ^{l}_{LDR}(k) and C^{l}_{HDR}(k).

FIG. 4 shows an image (410) obtained by uniformly quantizing the HDR sample image for display and a tone-mapped LDR image (420) using the TMO technique proposed by Reinhard et al.

It was checked from the experiment of each HDR sample image shown in FIG. 4 that even when a target image was different, the same conclusion was reached in the HDR predictor design according to the present invention.

Also, in the present invention, five TMOs were selected from several TMO techniques, and the correlation between Ĉ^{l}_{LDR}(k) and C^{l}_{HDR}(k) were tested with respect to the DC coefficient and the AC coefficient.

FIG. 5 is a diagram illustrating an example of distribution of AC coefficients for various TMOs according to an embodiment of the present invention.

The five TMO techniques used in FIG. 5 are designated by “Reinhard02”, “Drago03”, “iCAM06”, “Mantiuk08”, and “Mail1”. Also, the image quality coefficient q is preset to 70. The same distribution was observed in experiments with different image quality coefficients. Therefore, it was found that the effect of different image quality coefficients was at the negligible level in designing the HDR predictor.

More specifically, FIG. 5 shows the distribution of AC coefficients for Ĉ^{l}_{LDR}(k) of C^{l}_{HDR}(k) with respect to various TMO techniques. In each graph shown in FIG. 5, the horizontal axis denoted Ĉ^{l}_{LDR}(k), the vertical axis denoted C^{l}_{HDR}(k), the Y element is indicated with Y, the Cb element is indicated with Cb, and the Cr element is indicated with Cr.

It was checked from FIG. 5 that there was a very close correlation between the AC coefficient of C^{l}_{HDR}(k) and the AC coefficient of Ĉ^{l}_{LDR}(k) with respect to all Y, Cb, and Cr color elements. More specifically, in the case where the horizontal axis, which denoted Ĉ^{l}_{LDR}(k), was x and the vertical axis, which denoted C^{l}_{HDR}(k), was y, for example, when the “Reinhard02” TMO technique was used for “01” image, relational expressions, such as y=0.55x, y=0.28x, y=0.42x, and the like, were derived for each color element.

Also, when the image is changed or the TMO technique to be applied is changed, the correlation between the AC coefficient of C^{l}_{HDR}(k) and the AC coefficient of Ĉ^{l}_{LDR}(k), namely, the distribution of AC coefficients of C^{l}_{HDR}(k) and Ĉ^{l}_{LDR}(k) is also changed. For example, “03” image shows wider distribution than the other sample images with respect to all TMO techniques, and iCAM06 TMO technique shows wider distribution than the other TMO techniques with respect to all sample images.

However, it is clear that there is a very close correlation between the AC coefficient of C^{l}_{HDR}(k) and the AC coefficient of Ĉ^{l}_{LDR}(k) with respect to all Y, Cb, and Cr color elements. In the embodiment of the present invention, for the sample image and the TMO case, an approximate value of C^{l}_{HDR}(k) may be defined with the polynomial function of degree 1 of Ĉ^{l}_{LDR}(k). However, the correlation between the AC coefficient of the DCT domain data for the first dynamic-range image and the AC coefficient of the DCT domain data for the second dynamic-range image according to the present invention is not limited to the polynomial function of degree 1, and for example, it may be expressed in a polynomial, an exponential function, a logarithmic function, a trigonometric function, or the like

Accordingly, in the embodiment, prediction may be performed related to the AC coefficient with respect to each of the Y, Cb, and Cr color elements that are defined in the following Equation 1.

\tilde{C}^{l}_{HDR}(k)=a_{AC}Ĉ^{l}_{LDR}(k) [Equation 1]

In Equation 1, a_{AC} may denote a coefficient that minimizes the mean square error (MSE) between C^{l}_{HDR}(k) and Ĉ^{l}_{LDR}(k).

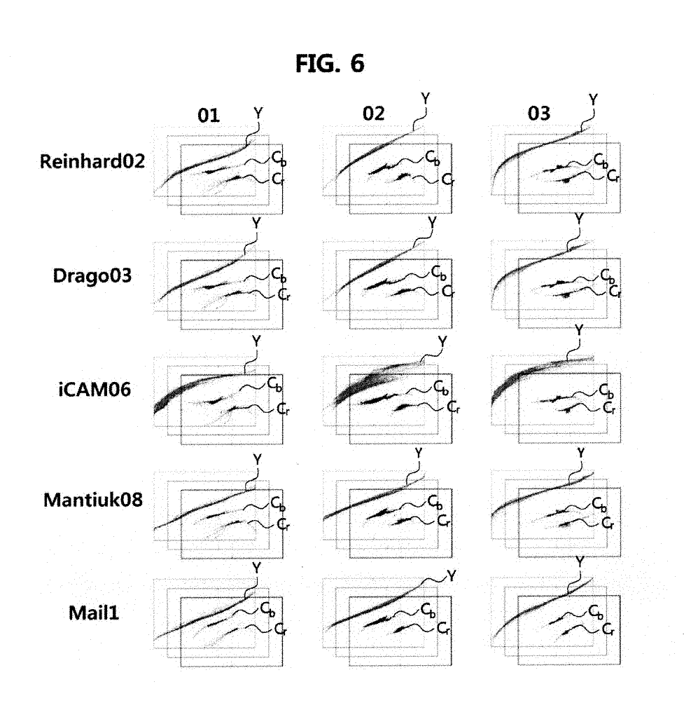

FIG. 6 is a diagram illustrating an example of distribution of DC coefficients for various TMOs according to an embodiment of the present invention.

Similar to FIG. 5, the five TMO techniques used in FIG. 6 are “Reinhard02”, “Drago03”, “iCAM06”, “Mantiuk08”, and “Mail1”. Also, the image quality coefficient q is preset to 70.

FIG. 6 shows the DC distribution of Ĉ^{l}_{LDR}(0) and C^{l}_{HDR}(0) with respect to various TMOs, and it is checked that the DC distribution of Ĉ^{l}_{LDR}(0) and C^{l}_{HDR}(0) is significantly different from the AC coefficient distribution of Ĉ^{l}_{LDR}(k) and C^{l}_{HDR}(k) shown in FIG. 5.

In FIG. 6, based on that the DC coefficient of the image reflects the averaged pixel value on a per-block basis and the TMO enhances the dynamic range of luminance, the distribution of C^{l}_{HDR}(0) to C^{l}_{LDR}(0) of Y element may be interpreted as a global aspect of the reverse operation of the TMO adopted for each image. Although the shapes of the distribution of Y, Cb, and Cr with respect to C^{l}_{HDR}(0) to Ĉ^{l}_{LDR}(0) differs from each other, the correlation between Ĉ^{l}_{LDR}(0) and C^{l}_{HDR}(0) is significantly high.

Therefore, according to the embodiment of the present invention, with a cubic equation function of Ĉ^{l}_{LDR}(0) defined in the following Equation 2, \tilde{C}^{l}_{HDR}(0) for each of the Y, Cb, and Cr color elements is predicted.

\tilde{C}^{l}_{HDR}(0)=a_{DC}[Ĉ^{l}_{LDR}(0)]³+b[Ĉ^{l}_{LDR}(0)]²+c[Ĉ^{l}_{LDR}(0)]+d [Equation 2]

In Equation 2, a_{DC}, b, c, and d denote coefficients that minimize the mean square error (MSE) between C^{l}_{HDR}(0) and Ĉ^{l}_{LDR}(0). That is HDR prediction according to the embodiment of the present invention may be performed using the least-squares method.

Prediction coefficients consisting of total 15 actual values, which may be defined by five constants a_{AC}, a_{DC}, b, c, and d with respect to each of three elements Y, Cb, and Cr, may be additionally contained in the residual-layer code stream.

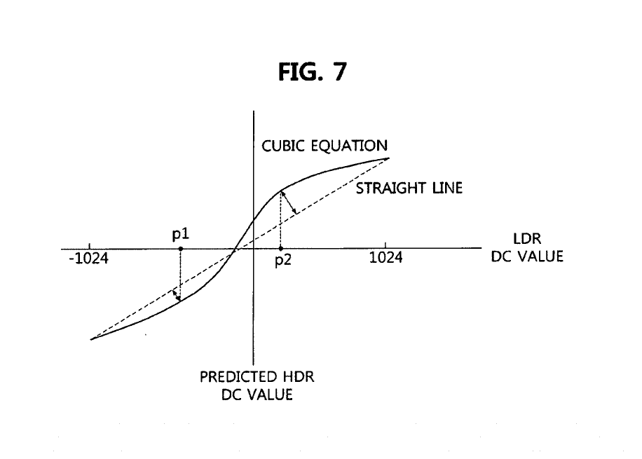

FIG. 7 is a graph illustrating a concept of deriving a predicted HDR DC value by section according to another embodiment of the present invention.

In the embodiment of FIG. 7, the x-axis is the LDR DC coefficient value, the y-axis is the predicted HDR DC coefficient value, and the LDR DC coefficient values range from −1024 to 1023.

It has been described that the coefficients a_{DC}, b, c, and d in Equation 2 are obtained using the least-squares method with reference to FIG. 6. The point (p1, p2) where the vertical distance from the point on a prediction curve defined by these coefficients to the straight line connecting the start point and the end point of the prediction curve is maximum in the positive (+) and negative (−) directions is found and is set as a reference point for dividing into sections. When the cubic equation does not meet the straight line, p1 and p2 are arbitrarily set to −200 and 200. However, p1 and p2 are not limited to −200 and 200.

Referring to the graph shown in FIG. 7, a curve defined as the cubic equation is divided into three sections based on p1 and p2, and the optimum prediction curve coefficient may be extracted for each section. The equation for predicting the HDR DC coefficient value, which is defined according to the embodiment shown in FIG. 7, may be defined as shown in the following Equation 3.

$${\tilde{C}}_{HDR}^{l} ( 0 ) = \{ \begin{matrix}\begin{matrix}{{a}_{DC 1} [ {\hat{C}}_{LDR}^{l} ( 0 ) ]}^{3} + {{b}_{1} [ {\hat{C}}_{LDR}^{l} ( 0 ) ]}^{2} + \\ {c}_{1} [ {\hat{C}}_{LDR}^{l} ( 0 ) ] + {d}_{1} , - 1024 \leq {\hat{C}}_{LDR}^{l} ( 0 ) < p 1\end{matrix} \\ \begin{matrix}{{a}_{DC 2} [ {\hat{C}}_{LDR}^{l} ( 0 ) ]}^{3} + {{b}_{2} [ {\hat{C}}_{LDR}^{l} ( 0 ) ]}^{2} + \\ {c}_{2} [ {\hat{C}}_{LDR}^{l} ( 0 ) ] + {d}_{2} , p 1 \leq {\hat{C}}_{LDR}^{l} ( 0 ) < p 2\end{matrix} \\ \begin{matrix}{{a}_{DC 3} [ {\hat{C}}_{LDR}^{l} ( 0 ) ]}^{3} + {{b}_{3} [ {\hat{C}}_{LDR}^{l} ( 0 ) ]}^{2} + \\ {c}_{3} [ {\hat{C}}_{LDR}^{l} ( 0 ) ] + {d}_{3} , p 2 \leq {\hat{C}}_{LDR}^{l} ( 0 ) < 1024\end{matrix}\end{matrix} \qquad [ Equation 3 ]$$

In Equation 3, a_{DC1}, b1, c1, and d1 are coefficients for section 1 (−1024 to p1), a_{DC2}, b2, c2, and d2 are coefficients for section 2 (p1 to p2), and a_{DC3}, b3, c3, and d3 are coefficients for section 3 (p2 to 1024).

However, the three sections defined in Equation 3 are merely illustrative, and the prediction function according to the present invention may be divided into arbitrary N sections. Each section may be defined as a prediction function in various forms, for example, a polynomial, an exponential function, a logarithmic function, a trigonometric function, and the like.

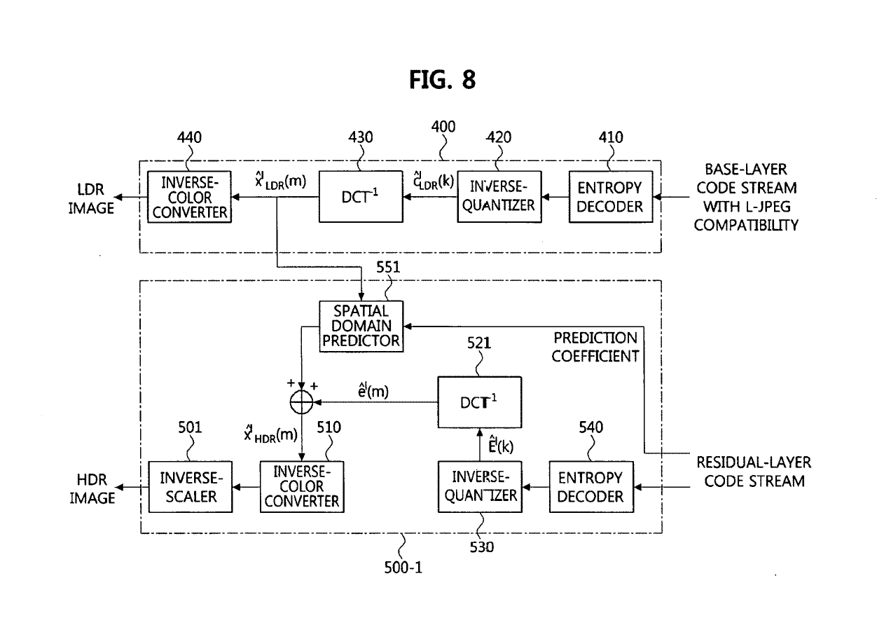

FIG. 8 is a block diagram illustrating a configuration of an HDR image decoder according to another embodiment of the present invention.

FIG. 8 shows a decoder according to an embodiment different from the HDR image decoder according to an embodiment shown in FIG. 3. The decoder shown in FIG. 8 processes, in the spatial domain, the residual-layer code stream encoded using the HDR predictor in the DCT domain. Therefore, the decoder according to the embodiment converts the residual data expressed in the DCT domain into the spatial domain, and performs HDR prediction in the spatial domain.

The HDR image decoder shown in FIG. 8 according to another embodiment of the present invention may include: a decoder 400 processing a legacy-JPEG compatible base-layer code stream; and an enhancement-layer decoder 500 including a spatial domain predictor 551, the entropy decoder 540, the inverse-quantizer 530, the inverse-color converter 510, and the inverse-scaler 501, the enhancement-layer decoder processing a residual-layer code stream.

In the embodiment of FIG. 8, base-layer decoding is performed by the conventional legacy-JPEG decoder 400, and the legacy-JPEG decoder 400 may include the entropy decoder 410, the inverse-quantizer 420, the inverse-discrete cosine transformer 430, and the inverse-color converter 440.

The base-layer code stream input to the image decoder shown in FIG. 8 is converted into a stream in the quantized form by the entropy decoder 410, and is converted into Ĉ^{l}_{LDR}(k) expressed in the DCT domain by the inverse-quantizer 420. Ĉ^{l}_{LDR}(k) is converted into \hat{x}^{l}_{LDR}(k) by the inverse-discrete cosine transformer 430, and is finally converted into the LDR image expressed in RGB by the inverse-color converter 440.

In the meantime, the prediction coefficients contained in the residual-layer code stream are input to the spatial domain predictor 551. The residual-layer code stream is converted into the DCT coefficient Ê^{l}(k) of the residual signal through the entropy decoder 540 and the inverse-quantizer 530, and the DCT coefficient of the residual signal is converted into ê^{l}(m) by the inverse-discrete cosine transformer 521. ê^{l}(m) is added to the output from the spatial domain predictor 551, and the result is input to the inverse-color converter 510, and is finally recovered into the HDR image by the inverse-scaler 510.

More specifically, the spatial domain predictor 551 receives the prediction coefficients contained in residual-layer code stream from the encoder and the base-layer data \hat{x}^{l}_{LDR}(k), on which inverse-DCT is performed, as input, and performs HDR prediction.

Related to this, the result of performing inverse-DCT (IDCT) on the DCT coefficient Ĉ^{l}_{HDR}(k) of the HDR image recovered in the DCT domain shown in FIG. 3 is the same as \hat{x}^{l}_{HDR}(m) shown in FIG. 8. \hat{x}^{l}_{HDR}(m) in the spatial domain may be expressed an operation on Ĉ^{l}_{HDR}(k) in the DCT domain as shown in the following Equation 4.

$$\begin{matrix}{\hat{x}}_{HDR}^{l} ( m ) = IDCT \{ {\hat{C}}_{HDR}^{l} ( k ) \} \\ = IDCT \{ {\hat{E}}^{l} ( k ) + {\tilde{C}}_{HDR}^{l} ( k ) \} \\ = IDCT \{ {\hat{E}}^{l} ( k ) \} + IDCT \{ {\tilde{C}}_{HDR}^{l} ( k ) \}\end{matrix} \qquad [ Equation 4 ]$$

Here, Ê^{l}(k) is the DCT coefficient of the residual signal transmitted via the residual-layer code stream. In Equation 4, an inverse-DCT operation is performed on Ĉ^{l}_{HDR}(k) to derive \hat{x}^{l}_{HDR}(m).

In the meantime, with respect to the second and third expressions of Equation 4, inverse-DCT is performed on a signal \tilde{C}^{l}_{HDR}(k) predicted by the HDR predictor according to the embodiment of the present invention, and it expands to be expressed by the value of the residual image on which inverse-DCT is performed. Therefore, the HDR image \hat{x}^{l}_{HDR}(m) recovered in the spatial domain may be the sum of the recovered residual image and the recovered predicted HDR image.

In order to recover the residual-layer code stream encoded using the HDR predictor in the DCT domain into the HDR image in the spatial domain, Equation 4 expands.

First, when

$$\frac{{\tilde{C}}_{HDR}^{l} ( 0 )}{{\hat{C}}_{LDR}^{l} ( 0 )}$$

is a^{l}_{DC}, it may be summarized as the following Equation 5.

$${a}_{DC}^{l} = \frac{{\tilde{C}}_{HDR}^{l} ( 0 )}{{\hat{C}}_{LDR}^{l} ( 0 )} = \frac{{{a}_{DC} [ {\hat{C}}_{LDR}^{l} ( 0 ) ]}^{3} + {b [ {\hat{C}}_{LDR}^{l} ( 0 ) ]}^{2} + c [ {\hat{C}}_{LDR}^{l} ( 0 ) ] + d}{{\hat{C}}_{LDR}^{l} ( 0 )} \qquad [ Equation 5 ]$$

Referring back to Equation 4, in order to calculate IDCT{\tilde{C}^{l}_{HDR}(k)}, \tilde{C}^{l}_{HDR}(k) is factored into the DC component and the AC component as shown in the following Equation 6.

$$\begin{matrix}IDCT \{ \begin{matrix}DC \text{:} {\hat{C}}_{HDR}^{l} ( 0 ) \\ AC \text{:} {\hat{C}}_{HDR}^{l} ( k )\end{matrix} \} = IDCT \{ \begin{matrix}DC \text{:} {a}_{DC}^{l} {\hat{C}}_{LDR}^{l} ( 0 ) \\ AC \text{:} {a}_{AC}^{l} {\hat{C}}_{LDR}^{l} ( k )\end{matrix} \} \\ = IDCT \{ \begin{matrix}DC \text{:} ( {a}_{DC}^{l} - {a}_{AC} + {a}_{AC} ) {\hat{C}}_{LDR}^{l} ( 0 ) \\ AC \text{:} {a}_{AC} {\hat{C}}_{LDR}^{l} ( k )\end{matrix} \} \\ = IDCT \{ \begin{matrix}DC \text{:} ( {a}_{DC}^{l} - {a}_{AC} ) {\hat{C}}_{LDR}^{l} ( 0 ) \\ AC \text{:} 0\end{matrix} \} + IDCT \{ \begin{matrix}DC \text{:} {a}_{AC} {\hat{C}}_{LDR}^{l} ( 0 ) \\ AC \text{:} {a}_{AC} {\hat{C}}_{LDR}^{l} ( k )\end{matrix} \} \\ = ( {a}_{DC}^{l} - {a}_{AC} ) IDCT \{ \begin{matrix}DC \text{:} {\hat{C}}_{LDR}^{l} ( 0 ) \\ AC \text{:} 0\end{matrix} \} + {a}_{AC} IDCT \{ \begin{matrix}DC \text{:} {\hat{C}}_{LDR}^{l} ( 0 ) \\ AC \text{:} {\hat{C}}_{LDR}^{l} ( k )\end{matrix} \} \\ = ( {a}_{DC}^{l} - {a}_{AC} ) \frac{{\sum }_{i = 1}^{64} {\hat{x}}_{LDR}^{l} ( {m}_{i} )}{64} + {a}_{AC} {\hat{x}}_{LDR} ( m )\end{matrix} \qquad [ Equation 6 ]$$

In Equation 6, mᵢ denotes the i-th element of the 8×8 block including m. Through the expanded equation, it is checked that the decoding process in the existing DCT domain is possible using the pixel value in the spatial domain on which inverse-DCT is performed. Accordingly, the decoding process in the spatial domain according to the embodiment of the present invention may be performed by the decoder shown in FIG. 8.

In short, \hat{x}^{l}_{HDR}(m) which is the input value to the inverse-color converter 510 shown in FIG. 8 may be expressed by the following Equation 7.

$${\hat{x}}_{HDR}^{l} ( m ) = {\hat{e}}^{l} ( m ) + \frac{( {a}_{DC}^{l} - {a}_{AC} )}{64} \sum {\hat{x}}_{LDR}^{l} ( m ) + {a}_{AC} {\hat{x}}_{LDR}^{l} ( m ) \qquad [ Equation 7 ]$$

Here, ê^{l}(m) denotes the result of performing IDCT on the residual signal, and

$$\frac{( {a}_{DC}^{l} - {a}_{AC} )}{64} \sum {\hat{x}}_{LDR}^{l} ( m ) + {a}_{AC} {\hat{x}}_{LDR}^{l} ( m )$$

is a value calculated by the spatial domain predictor 551 as the result of predicting the HDR value using the recovered LDR value \hat{x}^{l}_{LDR}(m).

The HDR prediction method in the spatial domain according to the present invention may be summarized in the following Equation 8 in the more comprehensive concept.

$$y = A \times {\sum }_{i = 1}^{64} {\hat{x}}_{LDR}^{l} ( {m}_{i} ) + B \times {\hat{x}}_{LDR}^{l} ( m ) \qquad [ Equation 8 ]$$

In the embodiment of the present invention shown in FIG. 8, the decoding method in the spatial domain in the case where A is

$$\frac{( {a}_{DC}^{l} - {a}_{AC} )}{64}$$

and B is a_{AC}, is described. According to another embodiment of the present invention, the values of A and B may be replaced with other values.

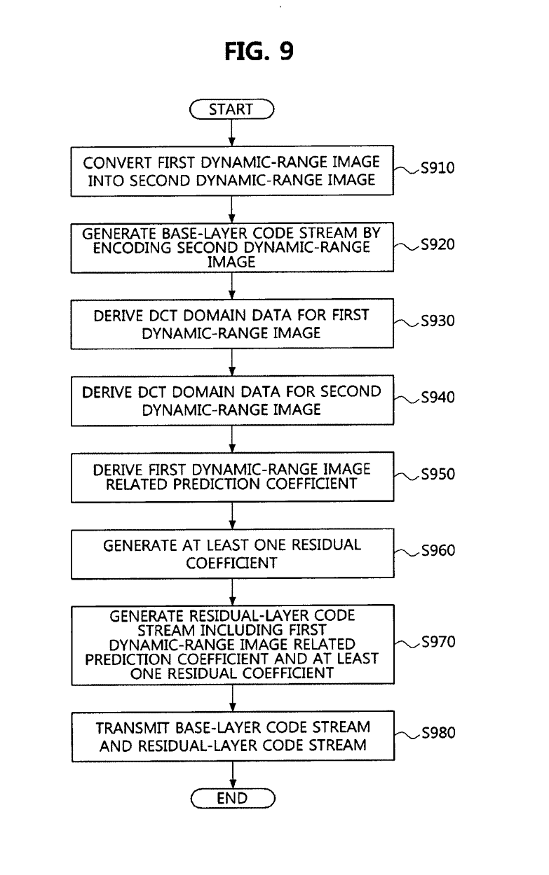

FIG. 9 is a flowchart illustrating operation of an encoding method according to an embodiment of the present invention.

The encoding method shown in FIG. 9 may be performed by the encoder shown in FIG. 2, but the performer is not limited thereto.

In the encoding method according to the embodiment of the present invention, first, the first dynamic-range image is converted into the second dynamic-range image at step S910, and the second dynamic-range image is encoded such that the base-layer code stream is generated at step S920. Here, the first dynamic-range image may be the HDR image, and the second dynamic-range image may be the LDR image.

Although not shown in FIG. 9 in detail, the generating of the base-layer code stream at step S920 may include: converting the first dynamic-range image into the second dynamic-range image by performing a tone-mapping operation thereon; performing color conversion on the second dynamic-range image; performing DCT on the color-converted image; quantizing the image on which DCT is performed; and entropy encoding the quantized image.

After, the DCT domain data for the second dynamic-range image is derived at step S930, and the DCT domain data for the first dynamic-range image is derived at step S940. The deriving of the DCT domain data for the first dynamic-range image at step S940 may include: performing scaling to the data range of the second dynamic-range image; performing color conversion on the scaled image; and performing DCT on the color-converted image. Here, for convenience of description, although it is described that steps S930 and S940 are sequentially executed, the two steps may be simultaneously executed, or step S930 may be executed before step S940. Also, although not particularly mentioned, according to the characteristics of steps described in FIG. 9, the two steps may be simultaneously executed or the sequence of the two steps may be reversed.

The derived DCT domain data for the second dynamic-range image and the derived DCT domain data for the first dynamic-range image are used to derive the first dynamic-range-image related prediction coefficient at step S950.

The first dynamic-range-image related prediction coefficient may be calculated using the correlation between the DCT domain data for the second dynamic-range image and the DCT domain data for the first dynamic-range image.

Here, the AC coefficient of the DCT domain data for the first dynamic-range image and the AC coefficient of the DCT domain data for the second dynamic-range image may have the correlation expressed in a function such as a polynomial of degree 1 as well as a polynomial, an exponential function, a logarithmic function, a trigonometric function, or the like.

Also, the DC coefficient of the DCT domain data for the first dynamic-range image and the DC coefficient of the DCT domain data for the second dynamic-range image have the correlation expressed by the prediction curve including multiple sections. Sections of the prediction curve may be defined by the same or different functions, such as a polynomial, an exponential function, a logarithmic function, a trigonometric function, and the like.

When the first dynamic-range-image related prediction coefficient is derived, the DCT domain data for the second dynamic-range image and the first dynamic-range-image related prediction coefficient are used to derive predicted DCT domain data for the first dynamic-range image, and at least one residual coefficient is generated at step S960. Here, the residual coefficient may be the DCT coefficient, and may be defined as a difference value between the DCT domain data for the first dynamic-range image and the predicted DCT domain data for the first dynamic-range image.

When the residual coefficient is generated, the residual-layer code stream that contains the first dynamic-range-image related prediction coefficient and at least one residual coefficient is generated at step S970. Here, the residual-layer code stream may contain the prediction coefficient.

When the residual-layer code stream is generated, the base-layer code stream and the residual-layer code stream are transmitted to the decoder at step S980.

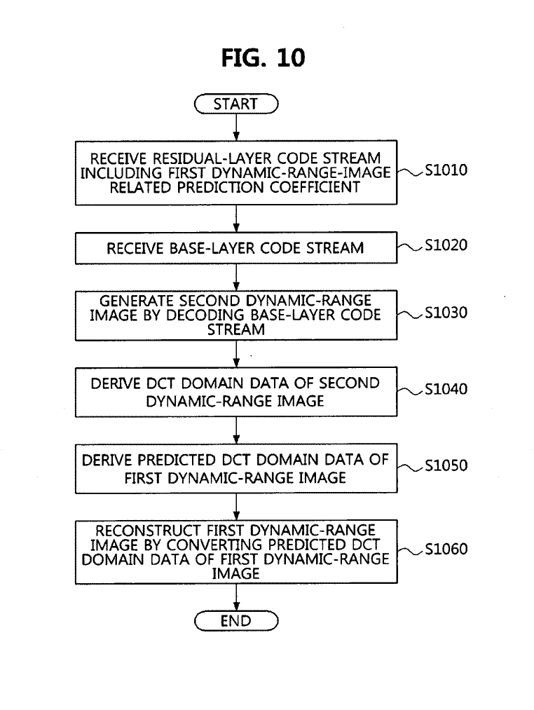

FIG. 10 is a flowchart illustrating operation of a decoding method according to an embodiment of the present invention.

The decoding method according to the embodiment of the present invention may be performed by the image decoder shown in FIG. 3, but the performer is not limited thereto.

The decoder receives the residual-layer code stream containing the first dynamic-range-image related prediction coefficient at step S1010. Also, the decoder receives the base-layer code stream at step S1020, and decodes the received base-layer code stream such that the second dynamic-range image is generated at step S1030. Here, for convenience of description, although it is described that steps S1010 and S1020 are sequentially executed, the two steps may be simultaneously executed, or step S1020 may be executed before step S1010. Also, although not particularly mentioned, according to the characteristics of steps described in FIG. 10, the two steps may be simultaneously executed or the sequence of the two steps may be reversed.

The decoder derives the DCT domain data for the second dynamic-range image at step S1040, and derives the predicted DCT domain data for the first dynamic-range image from the first dynamic-range-image related prediction coefficient and the DCT domain data for the second dynamic-range image at step S1050.

The decoder finally reconstructs the first dynamic-range image by converting the DCT domain data for the first dynamic-range image at step S1060. Here, for reconstruction of the first dynamic-range image, the DCT domain data for the first dynamic-range image is converted through processes such as inverse-DCT, inverse-color conversion, inverse-scaling, and the like.

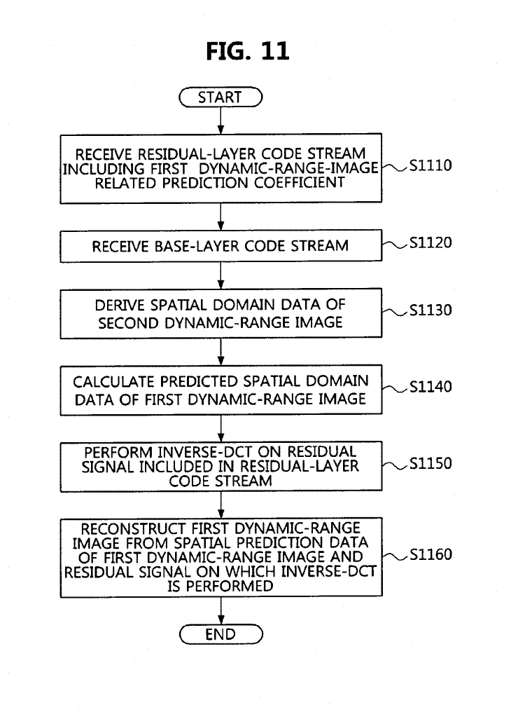

FIG. 11 is a flowchart illustrating operation of a decoding method according to another embodiment of the present invention.

The decoding method according to the embodiment of the present invention may be performed by the image decoder shown in FIG. 8, but the performer is not limited thereto.

The decoder receives the residual-layer code stream containing the first dynamic-range-image related prediction coefficient at step S1110. Also, the decoder receives the base-layer code stream at step S1120, and performs inverse-DCT on the received base-layer code stream such that the spatial domain data of the second dynamic-range image is derived at step S1130. Here, for convenience of description, although it is described that steps S1110 and S1120 are sequentially executed, the two steps may be simultaneously executed, or step S1120 may be executed before step S1110. Also, although not particularly mentioned, according to the characteristics of steps described in FIG. 11, the two steps may be simultaneously executed or the sequence of the two steps may be reversed.

After, the decoder calculates prediction-spatial-domain data of the first dynamic-range image from the first dynamic-range-image related prediction coefficient and the spatial domain data of the second dynamic-range image at step S1140. The decoder performs inverse-DCT on the residual signal contained in the residual-layer code stream at step S1150, and reconstructs the first dynamic-range image from the prediction spatial data of the first dynamic-range image and the residual signal on which inverse-DCT is performed at step S1160.

An experiment was performed that the performance of conventionally proposed JPEG XT profile encoding is compared to the performance of HDR image encoding according to the present invention as described in the above embodiments.

Generally, the encoding performance may differ depending on the adopted sample image and TMO. Therefore, as shown in FIGS. 5 and 6, three sample images “01”, “02”, and “03” and five TMO techniques were selected, and thus total 15 cases were experimented. Also, the experiment was performed on another sample image, and the same conclusion was reached in terms of performance comparison.

Further, for objective comparison, four image quality evaluation indexes were used. Related to this, recently, several studies have evaluated the performance of the JPEG XT profile. Hanhart et al. used 13 image quality evaluation indexes to observe the quality of HDR image compression using the JPEG XT profile. This evaluation concluded that “HDR visible difference predictor 2 (HDR-VDP-2)” is the most appropriate image quality evaluation index for the HDR image.

More specifically, Mantel et al. evaluated the objective image quality evaluation indexes of the signal-to-noise ratio (SNR), the mean relative square error (MRSE), and the HDR-VDP-2 to show the result of comparison evaluation in objective image quality of the HDR image compressed with the JPEG XT profile. Accordingly, it is found that the MRSE image quality evaluation index provides the most reliable result in using JPEG XT.

Valenzise et al. compared the performance of the HDR-VDP-2 image quality evaluation index with the performance of the peak SNR (PSNR) and the performance of the structural similarity index metric (SSIM). This was focused on HDR image encoding of the HDR image with backward compatibility. This study concluded that both PSNR and SSIM image quality evaluation indexes were capable of being effectively applied in measuring the image recovery fidelity for HDR image encoding.

Choi et al. evaluated the performance of the JPEG XT profile by comparing the encoding performance with the correlation of profiles by various TMOs using the PSNR image quality evaluation index.

In the present invention, PSNR, SSIM, HDR-VDP-2, and MRSE-based SNR were selected for performance comparison. PSNR and MRSE-based SNR used in the present invention are found in the following notations and definitions. In order to evaluate the case using SSIM and HDR-VDP-2, a program provided by the author of each image quality evaluation index was used.

Notations

X−{[xᵣ(m,n), x_{g} (m,n), x_{b}(m,n)]}, (m,n)∈Ω={1≤m≤M, 1≤n≤N}: original image, wherein M and N are the vertical and horizontal image sizes

xᵣ(m,n), x_{g}(m,n) and x_{b}(m,n): red, green, and blue constituents of a pixel positioned at the location (m,n) of an image X

\hat{X}={[\hat{x}ᵣ(m,n), \hat{x}_{g}(m,n), \hat{x}_{b}(m,n)]}: the encoded version of the original image X

### Definition

$$PSNR$$

$$PSNR = 10 {log}_{10} ( \frac{{DR}^{2} ( X )}{MSE ( X , \hat{X} )} )$$

$$where$$

$$DR ( X ) = {MAX}_{s ∈ \{ r , g , b \}} {MAX}_{( m , n ) ∈ Ω} \{ {x}_{s} ( m , n ) \} - {MAX}_{s ∈ \{ r , g , b \}} {MAX}_{( m , n ) ∈ Ω} \{ {x}_{s} ( m , n ) \}$$

$$and MSE ( X , \hat{X} ) = \frac{1}{3 MN} {MAX}_{s ∈ \{ r , g , b \}} {{MAX}_{( m , n ) ∈ Ω} [ {x}_{s} ( m , n ) - {\hat{x}}_{s} ( m , n ) ]}^{2} . \\ MRSE \text{-} based SNR$$

$${SNR}_{MRSE} = - 10 {log}_{10} ( MRSE ( X , \hat{X} ) )$$

$$where MRSE ( X , \hat{X} ) = \frac{1}{3 MN} {\sum }_{s ∈ \{ r , g , b \}} {\sum }_{( m , n ) ∈ Ω} \frac{{[ {x}_{s} ( m , n ) - {\hat{x}}_{s} ( m , n ) ]}^{2}}{{x}_{s}^{2} ( m , n ) + {\hat{x}}_{s}^{2} ( m , n )}$$

Although the above-described embodiments of the present invention have been described mainly with respect to the JPEG system, image encoding/decoding system to which the present invention is applicable is not limited to the JPEG. That is, the present invention is applicable to any system or device such as an MPEG system capable of video encoding and decoding, or an encoding or decoding system or device for images including still images or videos.

Operation of the encoding method and the decoding method according to the embodiments of the present invention may be is implemented as computer-readable programs or codes in a computer-readable recording medium. Examples of the computer-readable recording medium include all types of recording devices in which data readable by computer systems is stored. Also, the computer-readable recording mediums may be distributed to computer systems connected via networks and the computer-readable programs or codes may be stored and executed in a distribution manner.

Also, examples of the computer-readable recording medium include hardware devices, such as read-only memory (ROM), random-access memory (RAM), flash memory, and the like, which are particularly structured to store and implement program instructions. The program instructions include not only a mechanical language code formatted by a compiler but also a high level language code that may be implemented by a computer using an interpreter or the like.

Although some aspects of the present invention have been described in the context of a device, it is clear that these aspects also represent a description of the corresponding method, wherein a block or device corresponds to a method step or a feature of a method step. Analogously, aspects described in the context of a method also represent the feature of the corresponding block or item or the corresponding device. Some or all of the method steps may be executed by (or using) a hardware device, such as a microprocessor, a programmable computer, or an electronic circuit. In some embodiments, one or more of the most important method steps may be executed by such a device.

In the embodiments, a programmable logic element (for example, a field programmable gate array) may be used to perform some or all of the functions of the methods described herein. In the embodiments, the field programmable gate array may cooperate with a microprocessor in order to perform one of the methods described herein. Generally, the methods are advantageously performed by any hardware device.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

1. An image encoding method, comprising:
generating a base-layer code stream by converting a first dynamic-range image into a second dynamic-range image and encoding the second dynamic-range image;
deriving discrete cosine transform (DCT) domain data for the second dynamic-range image;
deriving DCT domain data for the first dynamic-range image; and
deriving a first dynamic-range-image related prediction coefficient using correlation between the DCT domain data for the second dynamic-range image and the DCT domain data for the first dynamic-range image.

2. The image encoding method of claim 1, wherein the first dynamic-range image is a high-dynamic-range (HDR) image, and the second dynamic-range image is a low-dynamic-range (LDR) Image.

3. The image encoding method of claim 1, further comprising:
generating at least one residual coefficient using predicted DCT domain data for the first dynamic-range image derived from the DCT domain data for the second dynamic-range image and the first dynamic-range-image related prediction coefficient; and
generating a residual-layer code stream including the first dynamic-range-image related prediction coefficient and the residual coefficient.

4. The image encoding method of claim 1, wherein the generating of the base-layer code stream comprises:
color-converting the second dynamic-range image;
performing DCT on the color-converted image;
quantizing the image on which DCT is performed; and
entropy encoding the quantized image.

5. The image encoding method of claim 4, wherein an image quality coefficient used at the quantizing of the image on which DCT is performed is equal to an image quality coefficient used in quantization of residual DCT domain data.

6. The image encoding method of claim 4, wherein the deriving of the DCT domain data for the second dynamic-range image comprises:
performing inverse-quantization on the quantized image.

7. The image encoding method of claim 1, wherein an AC coefficient of the DCT domain data for the first dynamic-range image and an AC coefficient of the DCT domain data for the second dynamic-range image have a correlation therebetween expressed in a polynomial, an exponential function, a logarithmic function, or a trigonometric function.

8. The image encoding method of claim 1, wherein a DC coefficient of the DCT domain data for the first dynamic-range image and a DC coefficient of the DCT domain data for the second dynamic-range image have a correlation therebetween expressed in a prediction curve including multiple sections, and
the sections of the prediction curve are defined by a same or different polynomials, exponential functions, logarithmic functions, or trigonometric functions.

9. An image decoding method, comprising:
receiving a residual-layer code stream including a first dynamic-range-image related prediction coefficient;
generating a second dynamic-range image by receiving a base-layer code stream and by decoding the received base-layer code stream;
deriving discrete cosine transform (DCT) domain data for the second dynamic-range image;
calculating DCT domain data for a first dynamic-range image from the first dynamic-range-image related prediction coefficient and the DCT domain data for the second dynamic-range image; and
reconstructing the first dynamic-range image from the DCT domain data for the first dynamic-range image.

10. The image decoding method of claim 9, wherein the first dynamic-range image is a high-dynamic-range (HDR) image, and the second dynamic-range image is a low-dynamic-range (LDR) image.

11. The image decoding method of claim 9, wherein the calculating of the DCT domain data for the first dynamic-range image comprises:
deriving the first dynamic-range-image related prediction coefficient and residual DCT domain data from the residual-layer code stream;
calculating predicted DCT domain data for the first dynamic-range image from the first dynamic-range-image related prediction coefficient and the DCT domain data for the second dynamic-range image using a correlation between the DCT domain data for the second dynamic-range image and the DCT domain data for the first dynamic-range image; and
calculating reconstructed DCT domain data for the first dynamic-range image from the predicted DCT domain data for the first dynamic-range image and the residual DCT domain data.

12. The image decoding method of claim 11, wherein an AC coefficient of the DCT domain data for the first dynamic-range image and an AC coefficient of the DCT domain data for the second dynamic-range image have a correlation therebetween expressed in a polynomial, an exponential function, a logarithmic function, or a trigonometric function.

13. The image decoding method of claim 11, wherein a DC coefficient of the DCT domain data for the first dynamic-range image and a DC coefficient of the DCT domain data for the second dynamic-range image have a correlation therebetween expressed in a prediction curve including multiple sections, and
the sections of the prediction curve are defined by a same or different polynomials, exponential functions, logarithmic functions, or trigonometric functions.

14. An image encoder, comprising:
a base-layer processor generating a base-layer code stream by converting a first dynamic-range image into a second dynamic-range image and encoding the second dynamic-range image;
an inverse-quantizer deriving discrete cosine transform (DCT) domain data by performing inverse-quantization on the second dynamic-range image quantized by the base-layer processor; and
an enhancement-layer processor deriving DCT domain data for the first dynamic-range image, deriving a first dynamic-range-image related prediction coefficient from the DCT domain data for the second dynamic-range image and the DCT domain data for the first dynamic-range image, and generating a residual-layer code stream from the first dynamic-range-image related prediction coefficient and the DCT domain data for the second dynamic-range image.

15. The image encoder of claim 14, wherein the enhancement-layer processor comprises:
a predictor calculating the first dynamic-range-image related prediction coefficient using a correlation between the DCT domain data for the second dynamic-range image and the DCT domain data for the first dynamic-range image.

16. The image encoder of claim 14, wherein the enhancement-layer processor is configured to,
generate at least one residual coefficient using predicted DCT domain data for the first dynamic-range image derived from the DCT domain data for the second dynamic-range image and the first dynamic-range-image related prediction coefficient; and
generate the residual-layer code stream including the first dynamic-range-image related prediction coefficient and the residual coefficient.

17. The image encoder of claim 16, wherein an image quality coefficient used in quantization of the second dynamic-range image performed by the base-layer processor is equal to an image quality coefficient used in quantization of residual DCT domain data performed by the enhancement-layer processor.

18. The image encoder of claim 14, wherein the base-layer processor comprises:
a color converter color-converting the second dynamic-range image;
a discrete cosine transformer performing DCT on the color-converted image;
a quantizer quantizing the image on which DCT is performed; and
an entropy encoder entropy encoding the quantized image.

19-22. (canceled)
